(19) United States
(12) Patent Application Publication
(10) Pub. No.: US 2007/0089384 A1
(43) Pub. Date: Apr. 26, 2007

(54) Particle filter, in particular for exhaust gases of internal combustion engines

(76) Inventors: Helmut Knoedl, Marbach-Rielingshausen (DE); Klaus Mueller, Tamm (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/560,909

(22) PCT Filed: May 7, 2004
(86) PCT No.: PCT/DE04/00957

§ 371 Date: Dec. 16, 2005

(30) Foreign Application Priority Data
Jun. 24, 2003 (DE) 103 28 188.6

(51) Int. Cl. B01D 46/00

(52) U.S. Cl. 55/385.3; 55/490

(57) ABSTRACT

A particle filter for exhaust gases of internal combustion engines, including a housing containing a filter body including a plurality of filter walls extending substantially in the radial and longitudinal direction and spaced apart from one another in the circumferential direction. The filter walls are welded at their face ends to at least one securing element by way of which the filter body is secured in the housing. The securing element has compensation means which act between the filter walls and the housing and compensate for relative motions between the filter walls and the housing. As a result, thermally caused motions of the filter walls can be compensated for, and stress in the region of the securing element can be avoided.

The invention relates to a particle filter, in particular for exhaust gases of internal combustion engines. The particle filter includes a housing and a filter body located in the housing. The filter body includes a plurality of filter walls, which, originating at a longitudinal axis of the particle filter, extend substantially in the radial direction and in the direction of the longitudinal axis. The filter walls are spaced apart from one another in the circumferential direction. The filter walls are welded at their face ends, at least in some regions, to at least one securing element, by way of which the filter body is secured in the housing.

### PRIOR ART

Particle filters are used particularly in conjunction with diesel engines, so that as soot filters they can reduce the unwanted expulsion of soot. Particle filters of the type defined at the outset are known for instance from German Patent Disclosure DE 101 28 938 A1, which in terms of the construction and mode of operation of a particle filter is expressly incorporated by reference here. However, the use of particle filters has not gained wide use, since they are not unproblematic in practice, particularly in terms of their storage capacity.

For some time, particle filters with an increased storage capacity have been tested; they have filter bodies with filter walls of a sintered metal. In them, metal fibers or grains are sintered together with a metal substrate mat to make filter plates. Various filter designs can be made from the plates. In particular, the filter plates can be used as filter walls for the filter body. As they flow through the filter walls, the soot particles are deposited onto their surface.

In a particular model of sintered metal filters. The filter body includes a plurality of filter walls, which, originating at a longitudinal axis of the particle filter, extend substantially in the radial direction and in the direction of the longitudinal axis, and which filter walls are spaced apart from one another in the circumferential direction. Two adjacent filter walls each form a so-called filter pocket. The filter body is secured to a securing element, which in turn is secured to the housing of the particle filter, so that via the securing element, the filter body is positioned in the housing and secured in it. The filter walls are soldered or welded to the securing element, at least in some regions, at least on their face end oriented in the axial direction.

From time to time, the particles that have accumulated in the particle filter must be removed from the particle filter. Typically, the particles are burned off at relatively high temperatures of approximately 550° C. and higher. This operation is also known as regeneration of the particle filter.

In the regeneration, the filter pockets become more highly heated than the securing element. Since the securing element is secured to the housing, the temperature differences and the resultant thermal expansion of the filter walls relative to the securing element create stresses in the weld seams or soldered connections with which the filter walls are secured to the securing element, and the stresses can even lead to breakage of the weld seams or soldered connections.

The object of the present invention is to design and further improve a particle filter of the type defined at the outset such that during the regeneration of the filter, stresses do not arise in the filter, and damage or even destruction of the weld seams or soldered connections between the filter walls and the securing element does not occur.

For attaining this object, taking the particle filter of the type defined at the outset as the point of departure, it is proposed that the securing element has compensation means, which act between the securing element and the housing and compensate for motions of the filter walls relative to the housing.

### ADVANTAGES OF THE INVENTION

In the particle filter of the invention, the filter pockets or filter walls, and the securing element to which they are secured, can expand virtually unhindered. This is especially important in the regeneration of the particle filter, since temperature differences inside the filter and, because of the high temperatures, a major thermal expansion of the filter pockets and the securing element can occur then. According to the invention, decoupling of the regions of the securing element that are joined to the filter pockets and of the regions of the securing element that are secured to the housing of the particle filter is attained by means of the compensation means. As a result, the regions of the securing element that are joined to the filter pockets are not hindered from expanding as needed with the filter pockets. As a result, the weld seams can expand virtually unhindered in the radial direction, and no stresses occur in the weld seams or soldered connections between the filter walls and the securing element. Stress fractures are thus prevented. Hence according to the invention, the filter pockets are not welded directly to the part of the securing element that is secured to the housing, but indirectly via the compensation means.

The particle filter may have only one securing element, or a plurality of securing elements, for instance a separate securing element for each filter pocket. The compensation means may be located between the housing and the securing elements.

In an advantageous refinement of the present invention, however, it is proposed that the compensation means are an integral component of the securing element. The compensation means may be embodied as a component that is separate from the securing element and is integrated with the securing element. However, it is also conceivable for the compensation means to be embodied in one piece with the securing element.

In a preferred embodiment of the present invention, it is proposed that the securing element has a radially outward-oriented outer flange, at which the regions of the securing element that are welded to the filter walls are secured on their side facing away from the longitudinal axis of the particle filter, and which flange is secured to the housing, and the compensation means are located between the outer flange and the regions of the securing element that are welded to the filter walls.

In a further preferred embodiment of the invention, it is proposed that the securing element has a radially outward-oriented outer flange, at which the regions of the securing element that are welded to the filter walls are secured on their side facing away from the longitudinal axis of the particle filter, and which flange is secured to the housing, and the compensation means are located between a first region of the outer flange, secured to the housing of the particle filter, and a second region of the outer flange, secured to the region of the securing element that is welded to the filter walls.

In still another preferred embodiment of the present invention, it is proposed that the securing element has a radially inward-oriented inner flange, at which the regions of the securing element that are welded to the filter walls are secured on their side facing toward from the longitudinal axis of the particle filter, and the compensation means are located between the regions of the securing element that are welded to the filter walls and the inner flange. In a particle filter with a cylindrically embodied filter body, the longitudinal axis of the particle filter extends through the inner flange, and the regions of the securing element that are welded to the filter walls come together at the inner flange, or these regions of the securing element are secured to the inner flange in the direction of the longitudinal axis.

In another advantageous refinement of the present invention, it is proposed that in the region of the compensation means, the securing element has a web of material that is folded at least once. In the region of the compensation means, a web of material with a plurality of web portions spaced apart from one another and located one above the other is provided. This multi-layer web of material in the region of the compensation means in particular makes a radial expansion of the weld seams between the filter walls and the securing element possible. Moreover, by means of the multi-layer web of material, the hot filter pockets are insulated from the outside, which makes for better and above all more effective regeneration of the particle filter, as well as a cooler temperature of the housing from the outside. Moreover, the filter pockets can be secured to the housing, via the multi-layer web of material of the compensation means, in such a way that mechanical vibrations or impact stresses that occur during operation are cushioned and the weld seams are no longer so greatly threatened with fracture from mechanical stresses.

Advantageously, the web of material has an areal extent that is essentially transverse to the motion of the securing element that is to be compensated for. It is advantageous if the areal extent of the web of materials extends substantially parallel to the longitudinal axis of the particle filter and in each case at a substantially constant spacing from the longitudinal axis. Preferably, the web of material is folded once or three times.

In another preferred embodiment of the present invention, it is proposed that support means are located in an intermediate region between the folded web portions of the web of material, which preferably include a corrugated support plate. It is also proposed that insulating means are located in an intermediate region between the folded web portions of the web of material, which preferably include rock wool.

Finally, it is proposed that at least one inward-curved bead is embodied at least in some regions in the circumferential direction on a radially inward-located folded web portion of the web of material. Preferably, the beads extend over the entire circumference of the inner web portion of the web of material, so that the filter pockets of the filter body can be braced in a way oriented radially inward.

Finally, it is proposed that the filter walls include a sintered material. Filter walls of a sintered material can be secured, preferably welded or soldered, to the securing element by their axial end faces.

### DRAWINGS

Further characteristics, possible applications, and advantages of the invention will become apparent from the ensuing description of exemplary embodiments of the invention, which are shown in the drawings. All the characteristics described or shown, on their own or in arbitrary combination, form the subject of the invention, regardless of how they are summarized in the claims or the claims dependencies and regardless of their wording in the description and their illustration in the drawings. Shown are:

FIG. 1, a particle filter according to the invention, in a first preferred embodiment, in a perspective sectional view;

FIG. 2, a particle filter known from the prior art, in a perspective view;

FIG. 3, a detail of a securing element of the particle filter of the invention, in a second preferred embodiment;

FIG. 4, a detail of a securing element of the particle filter of the invention, in the first preferred embodiment of FIG. 1;

FIG. 5, a detail of a securing element of the particle filter of the invention, in a third preferred embodiment;

FIG. 6, a detail of a securing element of the particle filter of the invention, in a fourth preferred embodiment;

FIG. 7, a detail of a securing element of the particle filter of the invention, in a fifth preferred embodiment;

FIG. 8, a detail of a securing element of the particle filter of the invention, in a sixth preferred embodiment;

FIG. 9, a detail of a securing element of the particle filter of the invention, in a seventh preferred embodiment;

FIG. 10, a detail of a securing element of the particle filter of the invention, in a eighth preferred embodiment;

FIG. 11, a detail of a securing element of the particle filter of the invention, in a ninth preferred embodiment;

FIG. 12, a detail of a securing element of the particle filter of the invention, in a tenth preferred embodiment;

FIG. 13, a detail of a securing element of the particle filter of the invention, in a eleventh preferred embodiment.

### DESCRIPTION OF THE EXEMPLARY EMBODIMENTS

In FIG. 2, a particle filter known from the prior art is shown in its entirety, identified by reference numeral 1. Particle filters are used particularly in conjunction with diesel engines, acting as soot filters to reduce the unwanted expulsion of soot. The particle filter 1 includes a housing 2 and a filter body 3 that in the operationally ready state of the particle filter 1 is located inside the particle filter. In FIG. 2, the filter body 3 is shown outside the housing 2. A longitudinal axis of the particle filter 1 is identified by reference numeral 4. The filter body 3 includes a plurality of filter walls 5, which extend, beginning at the longitudinal axis 4 of the particle filter 1, essentially in the radial direction and in the direction of the longitudinal axis 4. The filter walls 5 are spaced apart from one another in the circumferential direction. Each two adjacent filter walls 5 can form a so-called filter pocket. On their face end oriented upward in the axial direction, the filter walls 5 are secured, in particular welded or soldered, in at least some regions to a securing element 6.

The securing element 6 includes one rack 6a and one radially inward-oriented inner flange 6b. Regions 6c of the securing element 6 that are welded to the face ends of the filter walls 5 extend in the radial direction between the outer flange 6a and the inner flange 6b. The outer flange 6a, the regions 6c, and the inner flange 6b are rigidly joined together and in particular comprise one part. When the filter body 3 is inserted into the housing 2, the outer flange 6a comes into contact with a suitably embodied region 2a of the housing 2. In the outer flange 6a and in the region 2a of the housing 2, openings 6d and 2b are embodied, through which suitable fastening means, such as screws, can be passed in order to position the filter body 3 in the housing 2 and secured in the desired position. Instead of the fastening means that are passed through the openings 6d and 2b, the outer flange 6a may also be secured in some other way to the region 2a of the housing 2, for instance by means of a welded connection.

The filter walls 5 include a sintered metal. For the production of the filter walls 5, metal fibers or grains are sintered together with a metal substrate mat. As exhaust gas from a diesel engine flows through the particle filter 1, soot particles are deposited onto the surface of the filter plates 5. From time to time, the particle filter must be freed of the soot particles, in what is called a regeneration phase. To that end, the particle filter 1 is heated to a very high temperature, in the range of over 550° C., so that the soot particles will burn off in a way that is as much as possible free of residue. In the regeneration, the filter walls 5 heat up to a greater extent than the outer flange 6a and the inner flange 6b. Since the outer flange 6a is secured to the housing 2, the major thermal expansion of the filter walls 5 and of the regions 6c of the securing element 6 that are joined to the face ends of the filter walls 5 causes severe stresses in the weld seams between the filter walls 5 and the regions 6c of the securing element 6.

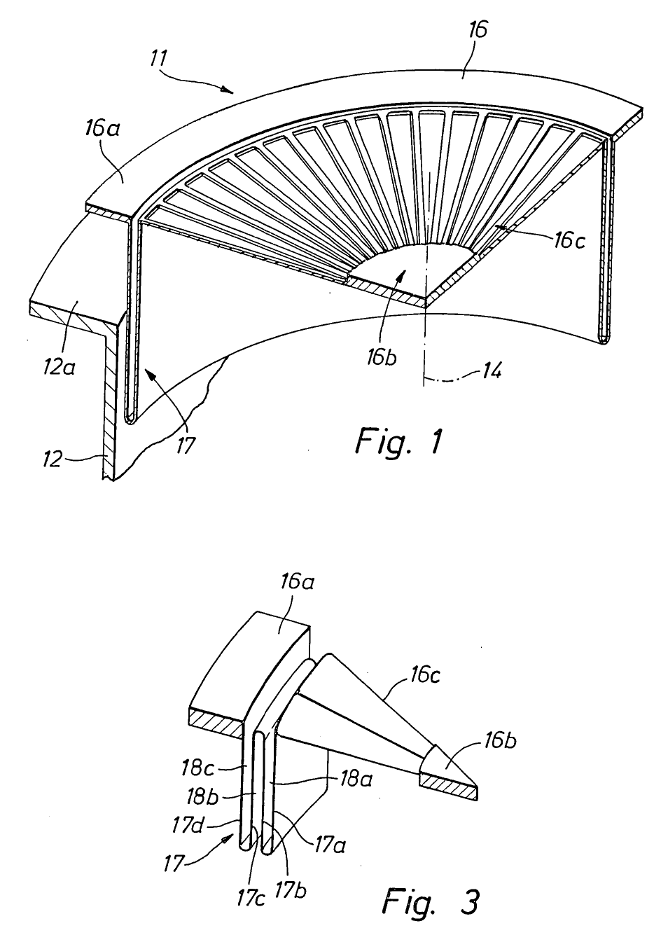

A remedy to this can be provided by the particle filter 11 of the invention, of the kind shown for instance in FIG. 1. In the particle filter 11 of the invention, the individual components have been designated by the same reference numerals as in FIG. 2, but increased by ten in each case. The particle filter 11 of the invention is shown in only fragmentary form in FIG. 1. For the sake of simplicity, the filter walls 15 in particular are not shown. However, the securing element 16 embodied in a special way can be seen, with the outer flange 16a, the inner flange 16b, and the regions 16c that are welded to the face ends of the filter walls 15. Compensation means 17 are integrated into the securing element 16 of the particle filter 11 of the invention, and by means of them a motion of the regions 16c of the securing element 16 that are welded to the filter walls 15, caused for instance by temperature changes, can be compensated for. Since in the particle filter 11 of the invention, the regions 16c of the securing element 16 are movable freely with the filter walls 15, stresses and resultant stress fractures of the weld seams can be effectively prevented.

In the exemplary embodiment shown in FIG. 1, the compensation means 17 and the securing element 16 are shown as one part. However, it is also conceivable for the compensation means 17 and the securing element 16 to be embodied as separate components. It is equally possible for the particle filter 11 to have not only a single securing element 16 but instead a plurality of securing elements, for instance one for each filter pocket.

The compensation means 17 in particular make a motion of the regions 16c of the securing element 16 in the radial direction possible. In the region of the compensation means 17, the securing element 16 has a web of material that is folded once, which has an areal extent essentially transverse to the motion to be compensated for of the securing element 16, namely parallel to the longitudinal axis 14 of the particle filter. In other words, the securing element 16 of the particle filter 11 of the invention, in the exemplary embodiment shown in FIG. 1, is embodied as a double-walled cylindrical shell.

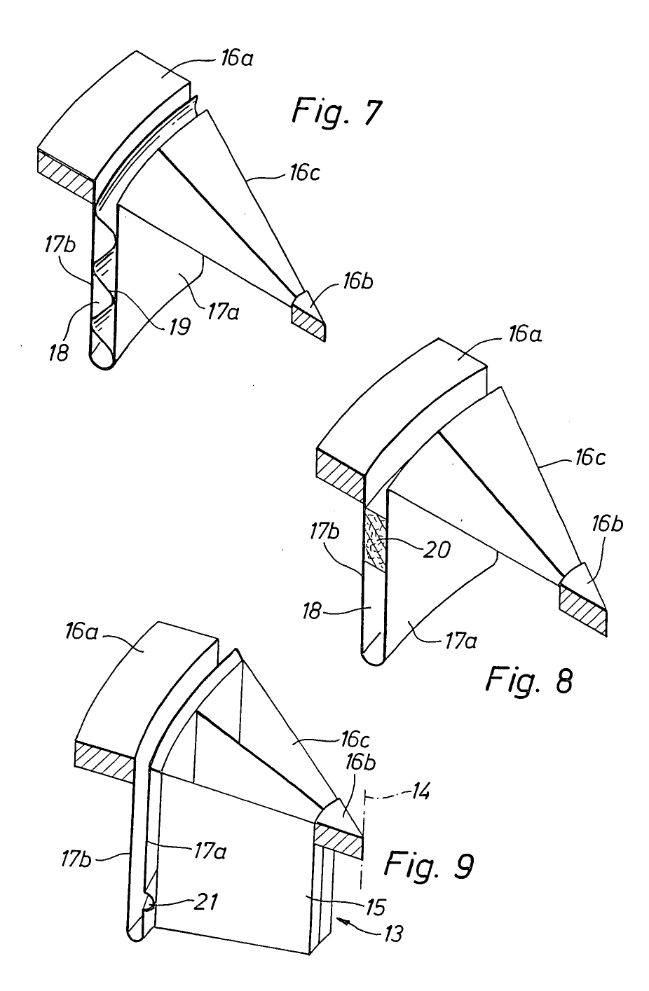

In the exemplary embodiment shown in FIG. 7, support means 19, for instance in the form of a corrugated support plate, may be located in an intermediate region 18 between the web portions 17a and 17b of the web of material of the compensation means 17. The support means 19 function for instance as a spring element or as an insulation element.

In an exemplary embodiment shown in FIG. 8, insulating means 20, for instance in the form of rock wool, may be disposed in the intermediate region 18 between the web portions 17a and 17b of the web of material of the compensation means 17. The insulating means 20 serve to heat-insulate the filter body 18 toward the outside, particularly during the regeneration of the particle filter 11. As a result, the regeneration can be designed to be more efficient, and the outside temperature of the housing 12 can be reduced.

A further advantage of the resilient binding of the filter walls 15 to the outer flange 16a is that vibrations or impact loads that occur during the operation of the internal combustion engine can be effectively cushioned, and the weld seams between the filter walls 15 and the regions 16c of the securing element 16 are also no longer so greatly threatened with fracture from mechanical stresses.

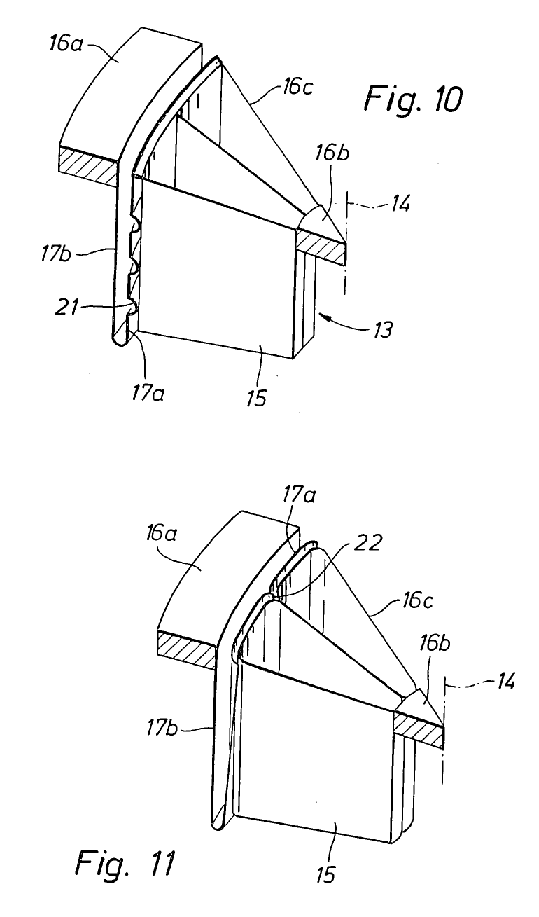

In the exemplary embodiment of the particle filter 11 of the invention shown in FIG. 9, at least one inward-curved bead 21 is embodied at least in some regions in the circumferential direction on the radially inward-located folded web portion 17a of the web of material of the compensation means 17. By means of the bead 21, the filter pockets formed by filter walls 15 located side by side can be braced. Instead of only one bead, a plurality of beads 21 extending in the circumferential direction may be provided (see FIG. 10) on the radially inward-located folded web portion 17a of the web of material of the compensation means 17.

In a further exemplary embodiment, shown in FIG. 11, of the particle filter 11 of the invention, inward-curved beads 22 are embodied in the longitudinal direction, parallel to the longitudinal axis 14 of the particle filter 11, on the radially inward folded web portion 17a of the web of material of the compensation means 17. By means of the beads 22, the stability of the filter pockets formed by the filter walls 15 can be improved.

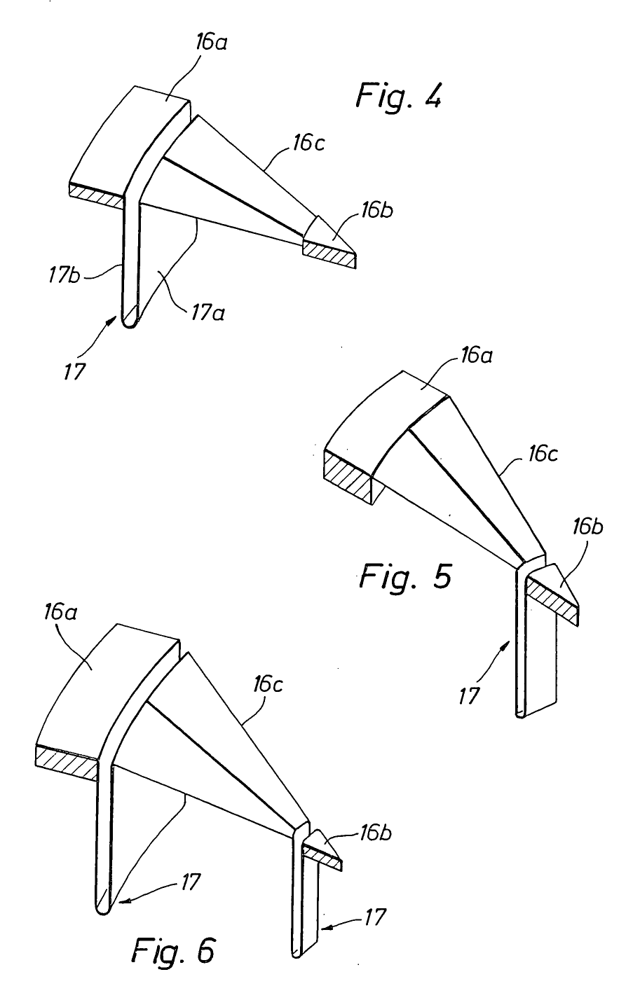

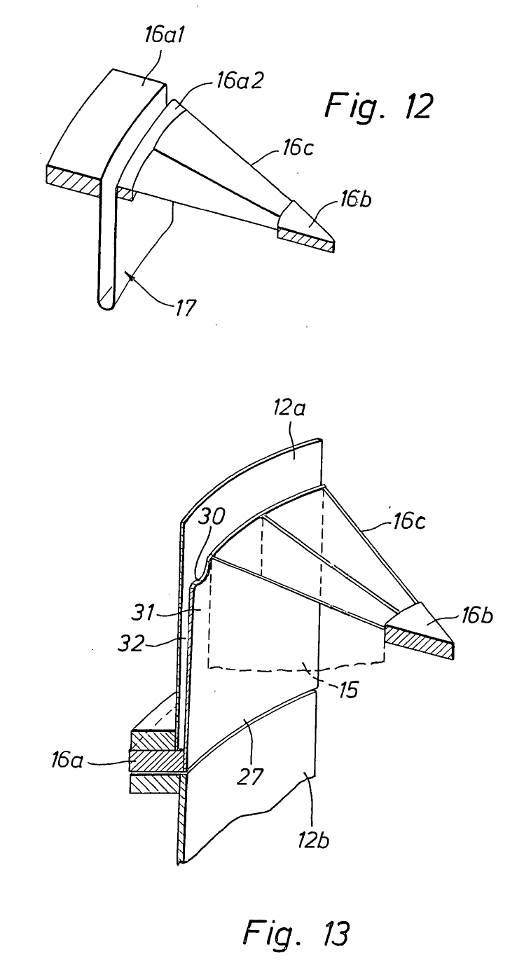

In a further exemplary embodiment, shown in FIG. 12, of the particle filter of the invention, the outer flange is subdivided into two annular partial regions 16a1 and 16a2, between which the compensation means 17 are located. The exemplary embodiment shown in FIG. 4 substantially corresponds to the exemplary embodiment shown in FIG. 1, with compensation means 17 in the form of a double-walled cylindrical shell.

In the exemplary embodiment shown in FIG. 5, the compensation means 17 are located between the regions 16c of the securing element 16, which are welded to the face ends of the filter walls 15, and the inner flange 16b. In this exemplary embodiment as well, an expansion or contraction motion of the filter walls 15 and/or of the regions 16c of the securing element 16, caused for instance by temperature changes, is compensated for by the compensation means 17. In the exemplary embodiment shown in FIG. 6, first compensation means 17 are provided between the outer flange 16a and the regions 16c of the securing element 16 that are welded to the filter walls 15, and second compensation means 17 are provided between the regions 16c and the inner flange 16b.

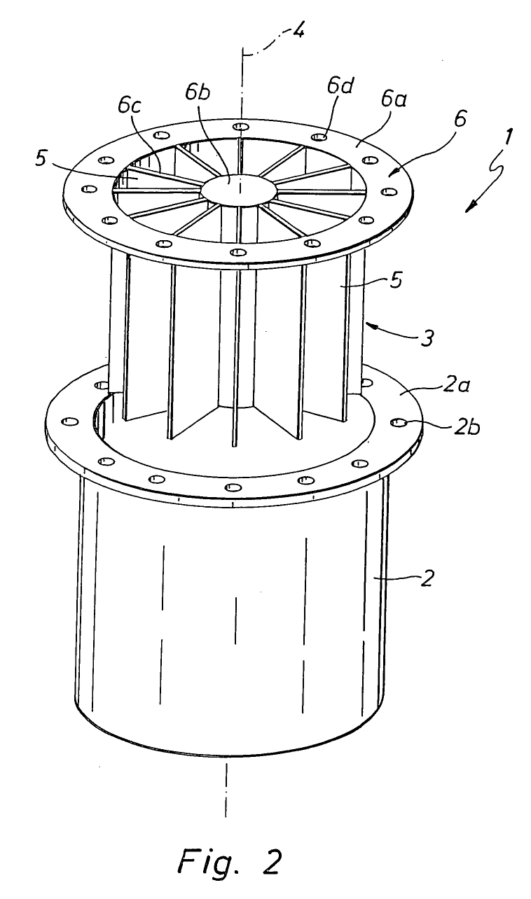

In the exemplary embodiment shown in FIG. 3, the securing element 16, in the region of the compensation means 17, has a triply folded web of material. The web of material in the region of the compensation means 17 thus includes four web portions 17a through 17d, spaced apart from one another, with three intermediate regions 18a through 18c embodied between them. In the exemplary embodiments of FIG. 7 and FIG. 8, arbitrary support means 19 and/or insulating means 20 may be located in the intermediate regions 18a through 18c. In other words, in the exemplary embodiment shown in FIG. 4, the securing element 16 is embodied as a quadruple-walled cylindrical shell.

It is a common feature of all the exemplary embodiments of the particle filter 11 of the invention that the regions 16c of the securing element 16 that are welded to the face ends of the filter walls 15 are movable, and that compensation means 17 are provided which prevent motions of the filter walls 15 and/or of the regions 16c from being able to lead to stresses and consequently stress fractures of the weld seams between the filter walls 15 and the regions 16c. This can be attained by means of arbitrarily embodied compensation means 17 and/or arbitrarily located compensation means 17.

In a further exemplary embodiment, shown in FIG. 13, the compensation means 17, which in FIG. 4 are subdivided into the portions 17a and 17b, can be limited to a single part, one compensation element 27, thereby saving both material and creative molding steps for the compensation means 17, and a lesser radial length of the entire arrangement compared to the housing 3 can be attained.

The compensation element 27 has an offset bend 30, in order to provide the spacing 31 between the filter wall 15 (shown in dashed lines) and the compensation element 27. The compensation element 27 is bound to the outer flange 16a of the securing element 16. The part 12a of the housing 12 located in the radial direction at the securing element 16 has a spacing 32 from the compensation element 27. The part 12b of the housing 12 that is oriented oppositely in the radial direction has the same inside diameter as the compensation element 27. In this embodiment, all the provisions described above (beads in the compensation element 27, support means and/or insulating means in the intermediate region with the spacing 32 between the compensation element 27 and the part 12c of the housing 12) may be present.

1-14. (canceled)

15. A particle filter for exhaust gases of internal combustion engines, the filter comprising,
a housing,
a filter body having a longitudinal axis located inside the housing and including a plurality of filter walls, originating at the longitudinal axis of the particle filter and extending substantially in the radial direction and in the direction of the longitudinal axis,
the filter walls being spaced apart from one another in the circumferential direction and being welded or soldered at their face ends, at least in some regions, to at least one securing element, by way of which the filter body is secured in the housing, and
compensation means acting between the securing element and the housing and compensating for motions of the filter walls relative to the housing.

16. The particle filter according to claim 15, wherein the compensation means are an integral component of the securing element.

17. The particle filter according to claim 16, wherein the securing element comprises a radially outward-oriented outer flange, at which the regions of the securing element that are welded to the filter walls are secured on their side facing away from the longitudinal axis of the particle filter, which flange is secured to the housing, and wherein the compensation means are located between the outer flange and the regions of the securing element that are welded to the filter walls.

18. The particle filter according to claim 16, wherein the securing element comprises a radially outward-oriented outer flange, at which the regions of the securing element that are welded to the filter walls are secured on their side facing away from the longitudinal axis of the particle filter, the flange being secured to the housing, and wherein the compensation means are located between a first region of the outer flange, secured to the housing of the particle filter, and a second region of the outer flange, secured to the region of the securing element that is welded to the filter walls.

19. The particle filter according to claim 17, wherein the securing element comprises a radially outward-oriented outer flange, at which the regions of the securing element that are welded to the filter walls are secured on their side facing away from the longitudinal axis of the particle filter, the flange being secured to the housing, and wherein the compensation means are located between a first region of the outer flange, secured to the housing of the particle filter, and a second region of the outer flange, secured to the region of the securing element that is welded to the filter walls.

20. The particle filter according to claim 16, wherein the securing element comprises a radially inward-oriented inner flange, at which the regions of the securing element that are welded to the filter walls are secured on their side facing toward from the longitudinal axis of the particle filter, and wherein the compensation means are located between the regions of the securing element that are welded to the filter walls and the inner flange.

21. The particle filter according to claim 17, wherein the securing element comprises a radially inward-oriented inner flange, at which the regions of the securing element that are welded to the filter walls are secured on their side facing toward from the longitudinal axis of the particle filter, and wherein the compensation means are located between the regions of the securing element that are welded to the filter walls and the inner flange.

22. The particle filter according to claim 18, wherein the securing element comprises a radially inward-oriented inner flange, at which the regions of the securing element that are welded to the filter walls are secured on their side facing toward from the longitudinal axis of the particle filter, and wherein the compensation means are located between the regions of the securing element that are welded to the filter walls and the inner flange.

23. The particle filter according to claim 17, wherein, in the region of the compensation means, the securing element comprises a web of material that is folded at least once.

24. The particle filter according to claim 18, wherein, in the region of the compensation means, the securing element comprises a web of material that is folded at least once.

25. The particle filter according to claim 23, wherein the web of material has an areal extent essentially transverse to the motions of the securing element that are to be compensated for.

26. The particle filter according to claim 24, wherein the web of material has an areal extent essentially transverse to the motions of the securing element that are to be compensated for.

27. The particle filter according to claim 23, wherein the web of material is folded once or three times.

28. The particle filter according to claim 25, wherein the web of material is folded once or three times.

29. The particle filter according to claim 23, further comprising support means located in an intermediate region between the folded web portions of the web of material.

30. The particle filter according to claim 29, wherein the support means comprises a corrugated support plate.

31. The particle filter according to claim 23, further comprising insulating means located in an intermediate region between the folded web portions of the web of material.

32. The particle filter according to claim 31, wherein the insulating means include rock wool.

33. The particle filter according to claim 23, further comprising at least one inward-curved bead embodied at least in some regions in the circumferential direction on a radially inward-located folded web portion of the web of material.

34. The particle filter according to claim 15, wherein the filter walls comprises a sintered metal.
